(19) United States
(12) Patent Application Publication
(10) Pub. No.: US 2022/0193862 A1
(43) Pub. Date: Jun. 23, 2022

(54) ABRASION METHOD

(71) Applicant: GEBE2 PRODUCTIQUE, SAINT-HILAIRE-DE-LOULAY (FR)

(72) Inventor: Nicolas De Roo, Montaigu (FR)

(21) Appl. No.: 17/601,496

(22) PCT Filed: Mar. 19, 2020
(86) PCT No.: PCT/EP2020/057653

§ 371 Date: Oct. 5, 2021

(30) Foreign Application Priority Data
Apr. 11, 2019 (FR) 19 03884

(51) Int. Cl. B24B 49/12; B24B 19/26; B24B 49/02; B24B 49/00

(52) U.S. Cl. CPC B24B 49/12; B24B 49/003; B24B 49/02; B24B 19/26

(57) ABSTRACT

A method for abrading a surface of a workpiece by means of an abrasion machine, including the following steps: (a) acquiring, with at least one sensor, on at least one portion of the surface of the workpiece, data in relation to at least one characteristic of the workpiece in at least two basic zones defined on the surface, processing, for each basic zone, the data in relation to the at least one characteristic in order to assign, to each basic zone and/or at least one group of basic zones, a value for this characteristic, determining and/or adjusting at least one abrasion parameter for the abrasion machine and/or an abrasion trajectory in accordance with the values attributed for the basic zones or group of basic zones, abrading at least a portion of the surface with the abrasion machine with the at least one abrasion parameter and the abrasion trajectory.

### TECHNICAL Field

The present invention relates to an abrasion method, notably for buffing workpieces, for example made of metal and/or of composite materials, notably workpieces intended for aeronautical, automobile, naval, wind turbine construction or other industries.

### PRIOR Art

Abrasion methods notably comprise buffing, polishing and grinding, sand-blasting and waterjet machining.

During the production of an industrial workpiece, the latter comprises a number of layers of base, preparation and finishing material, all of these layers themselves being able to be composed of multiple sublayers.

The function of the preparation layers is to ensure the mitigation of defects on different scales: micro- and macro-geometrical. For micro-geometrical defects, so-called “filler” finishing materials will usually be used, and for macro-geometrical defects, mastics will rather be used, both being deposited in layers. These two types of layers will be deposited one on top of the other, notably to fill the apparent defects on the workpiece.

Before depositing a finishing layer, for example of paint, there is generally an abrasion phase, notably a buffing phase, to make it possible to have an even surface with the least possible material. Indeed, and in particular for the aeronautical sector, the total weight of a workpiece must be as low as possible for energy-saving reasons in its use. The aim is therefore to buff the excess of material while retaining the structural and functional performance levels of the workpiece. As an example, structural can be understood to mean the mechanical strength of the workpiece and functional can be understood to means its aerodynamic performance. The objective of the buffing is therefore three-fold, making it possible at the same time to prepare the surface and remove material without removing too much.

It should be noted that some workpieces include sublayers that must not be touched. In the aeronautical field, one that can be cited among others is the lightning strike protection mesh layer which ensures resistance of the workpiece to lightning strikes.

There is currently no automated way of precisely controlling the removal of material by abrasion, notably by buffing, without the risk of degrading the machined workpiece.

The buffing is usually done manually. That makes it possible to control, to a certain extent, the removal of material, but not sufficiently with a view to automating the method. In a manual operation, it is also very difficult to obtain an even surface. Finally, there is really no repeatability, despite the experience of operators and each workpiece presents different defects.

It is therefore currently difficult to automate this method. However, this automation is absolutely necessary given the low added value provided by this operation. To be able to apply this transformation, it is necessary to have a better control of the material removed and remaining on the workpiece to achieve this objective.

US2002072297 presents an automatic surface finishing device and method, notably for airplane panels, for correcting the surface anomalies. The device thus comprises a controller, a plurality of scanning means and surface finishing tools, which make it possible to detect and treat the surface anomalies.

DE102015119240 presents an automatic method for detecting defects on the surface of a workpiece. The method makes it possible to locate and categorize, as a function of their topography, the workpiece surface defects. The document also presents a method for treatment of the detected defects by a robot.

There is currently no solution that makes it possible to confidently, rapidly and relatively inexpensively control the surface preparation of a workpiece, whether multilayer or single layer, notably made of metal, by material removal by means of abrasive methods such as, for example, grinding, buffing, polishing, sand-blasting and waterjet machining.

The invention therefore aims to address this need.

### SUMMARY OF THE INVENTION

The subject of the present invention is thus a method for abrading a surface of a workpiece by means of an abrasion machine, comprising the following steps:

(a) acquisition, with at least one sensor, on at least a part of the surface of the workpiece, of data relating to at least one characteristic of the workpiece in at least two basic zones defined on said surface,

(b) processing, for each basic zone, of the data relating to said at least one characteristic in order to assign, to each basic zone and/or to at least one set of basic zones, a value for this characteristic,

(c) determination and/or adjustment of at least one abrasion parameter of the abrasion machine and/or of an abrasion trajectory as a function of the values assigned for the basic zones or set or sets of basic zones,

(d) abrasion of at least a part of the surface with the abrasion machine with said at least one abrasion parameter, which may or may not be variable, and said abrasion trajectory.

The method can comprise at least one repetition of the steps (a) to (c) and possibly at least one repetition of the step (d).

The method can in particular comprise several repetitions of the steps (a) to (d), preferably at least two repetitions, for example five repetitions, the last repetition not including the step (d).

By virtue of the invention, it is possible to obtain information relating to the surface of the workpiece, which makes it possible to adjust the abrasion, notably the abrasion parameter or parameters and the trajectory followed. It is notably possible, by virtue of this method, rather than following the material removed from the workpiece by abrasion, to track, analyze and study the material remaining on the workpiece.

“Surface of the workpiece” is understood to mean the part of the surface of the workpiece which is to be abraded. This part of the surface to be abraded can correspond to all of the surface of the workpiece or only a portion thereof In the latter case, a part of all of the surface is to be abraded.

In one embodiment, the abrasion machine moves relative to the workpiece during the abrasion step (d), the workpiece then being preferably stationary. In another embodiment, the workpiece is moved relative to the abrasion machine during the abrasion step (d), the abrasion machine then preferably being stationary. In another embodiment, the workpiece and the abrasion machine are mobile with respect to one another, during the abrasion step (d).

The abrasion machine can be programmed with predetermined initial abrasion parameters and a predetermined initial abrasion trajectory. During the step (c) of the abrasion method, one or more of these parameters and/or the abrasion trajectory are determined, being for example retained with their initial characteristics or adjusted. The abrasion trajectory can thus be predetermined, in particular the initial abrasion trajectory, the step (c) then consisting, if necessary, in adjusting it if necessary.

The method comprises, for example after the step (c), the parameterizing of the abrasion machine with said at least one abrasion parameter and/or the abrasion trajectory.

Said at least one abrasion parameter may or may not be variable during the abrasion trajectory performed in the step (d), notably as a function of the values assigned for the basic zones or sets of basic zones.

Said at least one characteristic of the workpiece is preferably chosen from the group composed of a color, a dimension, notably a thickness, a surface condition such as a brightness or a roughness, a radiation, preferably a color.

When the or one characteristic consists of a color, it is for example possible to detect changes of color of the surface.

Said at least one characteristic of the workpiece can be a characteristic of the surface of the workpiece. When the method comprises the step consisting in acquiring data relating to at least two characteristics of the workpiece, at least one of these characteristics can be a characteristic relating to the surface of the workpiece, for example the color or the surface condition.

Said at least one sensor is notably chosen from the group composed of a sensor with or without contact based on optical, mechanical, magnetic, capacitive, acoustic, radiative and piezoelectric technologies. Said at least one sensor can be chosen from the group composed of, among others, cameras, color sensors and thermocouples.

The sensor makes it possible to acquire data relating to the characteristic.

Said at least one abrasion parameter can be chosen from among the following: speed of advance, speed of rotation or progress of the abrasive tool, effort applied by the abrasive tool on the surface of the workpiece, nature, form and/or size of the abrasive tool, angular orientation of the abrasive tool with respect to the local normal to the surface of the workpiece.

By performing the step of processing of the acquired data, it is possible to deduce therefrom the adjustment of one or more parameters, for example from among those indicated above, and also that of the abrasion trajectory of the machine and/or the workpiece, relatively.

The determination step (c) can comprise a comparison, for each basic zone, of said assigned value with a predetermined threshold value.

When, by implementation of the comparison, the threshold value for said at least one characteristic of the workpiece is reached in at least one basic zone of a set of basic zones, the abrasion trajectory is advantageously determined so that there is no longer abrasion in the set of basic zones concerned.

When, by implementation of the comparison, the threshold value for said at least one characteristic of the workpiece is reached for at least a predefined percentage of the surface, of basic zones or set or sets of basic zones, notably at least 80% of the surface, even greater than 80%, this percentage being able to range up to 100%, the abrasion method is stopped. It should be noted that, to reach said threshold value for more than 80% of the surface of the workpiece, it may be necessary to change all or part of the abrasive tool, notably change abrasive paper, abrasive table and/or abrasive tool.

The abrasion advantageously consists of a buffing. It can, as a variant or partially, consist of a polishing or a grinding or even any other abrasion method. The abrasion machine comprises an effector with an abrasion tool comprising an abrasive table possibly supporting an abrasive paper. The abrasion tool and/or the effector and/or the table and/or the paper can be adapted if necessary.

The surface of the workpiece can comprise a peripheral portion in proximity to at least one edge of the workpiece over a predetermined distance therefrom, said peripheral portion not being able to be treated by the abrasion machine or being able to be treated at least partially with the abrasion machine of which a part has been changed, notably of which an abrasive table of the abrasion machine has a smaller diameter, automatically or manually.

The workpiece is advantageously a workpiece with a flat or curved surface with, for example, a radius of curvature of between 3 and 5 m. The workpiece treated by the method according to the invention is, for example, relatively larger than the size of the abrasive tool.

The method can implement two sensors, notably of the same type or of different types, for the performance of the acquisition step (a). In the case where two sensors are different, that can make it possible to acquire data relating to two different characteristics, for example the color and the thickness. In the case where the sensors are of the same type, each of them can detect a datum of the characteristic, for example a single color, all of the data from the sensors making it possible to assign a value to the characteristic, for example the color of the basic zone concerned. It is then the processing of all of the acquired data which makes it possible to assign a value to the characteristic for a particular basic zone.

In a particular embodiment, the sensor or sensors can comprise a color detection sensor and the value assigned to each basic zone consists of a color. In this case, the threshold value can then consist of a predetermined change of color. It should be noted that there can be one or more changes of color before reaching the change of color forming the threshold value.

A mapping of the surface can be produced comprising a plurality of said basic zones.

The basic zones can be of mutually identical form and/or surface area. As a variant, two basic zones can differ from one another by their form and/or their surface area.

A set of basic zones can be defined as comprising a plurality of basic zones present within a predetermined radius around a given point of the surface of the workpiece, the predetermined radius corresponding, for example, to that of an abrasive table of the abrasion machine. Thus, for each given point of an initial abrasion trajectory, it is possible to define a set of basic zones around this point, the surface of which corresponds, for example, to that of the abrasive table.

Thus, it is possible to perform the processing of the data acquired on each of the basic zones and/or for each set of basic zones, to be able to determine and/or adjust the parameter or parameters of the abrasion machine and/or the abrasion trajectory upon the implementation of the abrasion.

### Acquisition Step

The acquisition in the step (a), which can correspond to a measurement phase, can be performed by a scanning of at least a part of the surface of the workpiece, for example along a predefined trajectory. The scanning trajectory is, for example, formed by points that are evenly spaced apart, for example 50 mm apart from one another. The scanning is advantageously performed continuously over all of the trajectory, for example at a speed of approximately 500 mm.s⁻¹, maximized according to the acquisition frequency and the fuzzy effect. The triggering of a measurement by the sensor or sensors can be done during the scanning at each point encountered or independently of the points encountered, preferably at regular intervals. The space between two measurements obviously depends on the resolution sought. This space can be less than twice the diameter of the abrasive tool. As a variant, or additionally, a triggering of a measurement by the sensor or sensors can be performed at time intervals and/or distance intervals, regular or not, over all of the surface to be scanned.

Each of these measurements can correspond or not to a basic zone. When several measurements correspond to a basic zone, at least one criterion, for example an average or hierarchic criterion, can be defined to assign a value to the basic zone. When a measurement is performed for a basic zone, the value assigned to that zone can directly correspond to the datum recorded in the basic zone. A measurement can, as a variant, be performed for several basic zones, simultaneously, for example four basic zones, the field of view of the sensor covering multiple basic zones simultaneously. It is then possible to assign a value for each basic zone and/or for all of the basic zones for which the measurement was performed.

The acquisition can be performed in an environment without light, possibly except for a lamp illuminating at an instant t the part of the surface on which the acquisition is performed by the sensor or sensors at that instant t. Such a lamp can be incorporated in the sensor or in the tool supporting the sensor. That makes it possible to have an image of uniform and constant brightness over all the surface of the workpiece.

As a variant, the acquisition is performed in an environment with light.

In a particular embodiment, a color detection sensor is used coupled to a thickness sensor.

In a particular embodiment, the measurement of the coating thickness, notably the thickness of paint, is not performed.

### Processing step

The processing in the step (b), which can correspond to a computation phase, can make it possible to assign a value to each basic zone and/or to each set of basic zones. Each set of basic zones has a surface corresponding, for example, to a surface of the abrasive table of the abrasion machine, notably the buffing machine, which will subsequently make it possible to perform the abrasion, notably the buffing, around a given point of the abrasion trajectory. In fact, the instantaneous surface of abrasion corresponds to the surface of the table and this surface can encompass one or more basic zones, corresponding to a set of basic zones. Thus, the processing phase can make it possible to assign a value to each basic zone and/or to each set of basic zones, preferably, a value to each basic zone then a value to each set of basic zones determined from the values of the basic zones of the set of basic zones.

In particular, from the data acquired by the sensor or sensors, it is first of all possible to assign a value to each basic zone, then assign a value to each set of basic zones for a given point of the abrasion trajectory, this value of the set being a function of the value of each basic zone of the set. The value of the set can, for example, correspond to an average, which can be weighted, of the values of the basic zone and/or to a predominant value of a basic zone of the set and/or another criterion. For example, if a value of a basic zone of the set has reached the threshold value, it is then possible to assign the threshold value to that set.

### Step of Determination and/or Adjustment of the Abrasion Parameter or Parameters and of the Abrasion Trajectory

In this step, the aim is to determine the abrasion parameter or parameters and the abrasion trajectory of the abrasion machine as a function of the values assigned in the preceding step. In particular, it is possible to define the trajectory to be taken during the abrasion by the abrasive table so as not to produce abrasion in the basic zone or zones or set or sets of basic zones to be excluded because they have reached a predetermined threshold value. It is possible to adjust a parameter such as the speed of advance, this speed being able to be increased locally to reduce the abrasion of a set of zones for example or over the entire trajectory.

Initial abrasion parameters can be predefined.

The abrasion trajectory can comprise several discrete trajectory sections or a single continuous trajectory. Between the possible sections, the abrasion machine will be able to stop abrasion and/or move away from the surface to the next section, notably in basic zones to be excluded from the abrasion.

The initial trajectory, for example predetermined, is advantageously continuous. The adjusted trajectory, notably after a first, second or third abrasion, can be discontinuous to exclude certain zones, and nevertheless makes it possible to treat all of the surface of the workpiece which has to be treated by abrasion. A trajectory can be defined to treat only the zones to be treated. The initial trajectory can be designed to have the most uniform possible abrasion. The initial abrasion parameters can comprise a minimum speed of advance.

All or part of the abrasion parameters can be adjusted for the entire trajectory, then being non-variable over that trajectory. As a variant, all or part of the abrasion parameters can be variable along the trajectory, notably as a function of the values assigned for the basic zones and/or sets of basic zones encountered on the trajectory.

Parameters, other than those mentioned above, can be modified, such as a change of a disk for a new disk and/or for a different abrasion grain size, notably going to a lesser abrasion as the abrasions progress to reduce the removal of material.

Another parameter to be adjusted can be the abrasion effort or even the speed of rotation.

When the abrasion machine includes a compliance, the control effort of the compliance can be adjusted.

It is even possible, as parameter, to modify the diameter of the abrasive table, for example for a table that has a surface of different diameter, notably smaller as the abrasions progress, to reduce the surface of removal of material at a given instant. The processing of the data will then advantageously be adapted to this new diameter, notably for the basic zones forming a set around a given point.

### Acquisition Tool and Abrasion Machine

The acquisition tool making it possible to implement the acquisition step (a) can be distinct, or not, from the abrasion machine used to perform the abrasion step.

In particular, one and the same robot can bear the acquisition tool and the abrasion machine. The robot can comprise the processing and computation tool for the implementation of the steps (b) and (c). The robot can be able to implement all of the steps of the method.

The acquisition tool can comprise a sensor borne by a robotized arm, notably a multi-axis robotized arm.

The abrasion machine can comprise an effector bearing an abrasion tool bearing the abrasive table, notably a buffing tool, and possibly a compliance. The abrasive table is advantageously rotary, with or without eccentric, being controlled in rotation by the abrasion tool or, preferably, being able to rotate freely. The table can be rigid or flexible, for example with a foam added.

### BRIEF DESCRIPTION OF THE DRAWINGS

The invention will be better understood on reading the following description of nonlimiting embodiments thereof, and on studying the attached drawing, in which:

FIG. 1 represents, in a block diagram, the different steps of a method according to the invention,

FIG. 2 schematically represents, in perspective, an example of implementation of the acquisition step of the method according to the invention,

FIG. 3 schematically represents an example of result of the processing step of the method according to the invention for certain basic zones,

FIG. 4 schematically represents an example of mapping that can be established in the processing of the data with a view to the parameterizing step of the method according to the invention,

FIG. 5 schematically represents, in perspective, an example of implementation of the abrasion step of the method according to the invention,

FIG. 6 represents an example of mapping of the surface of the workpiece after implementation of the processing step,

FIG. 7 represents the mapping of FIG. 6 in which certain zones have been excluded from a subsequent abrasion,

FIG. 8 represents the mapping of FIG. 7 in which at least a part of the trajectory of the abrasion machine has been plotted,

FIG. 9 represents, in perspective and schematically, the surface of a workpiece to be abraded using the method according to the invention,

FIG. 10 represents a mapping of the surface of the workpiece of FIG. 9 before abrasion,

FIG. 11 represents the mapping of the surface of the workpiece of FIG. 9 after three repetitions of the steps of the method according to the invention,

FIG. 12 represents, in perspective and schematically, the surface of the workpiece of FIG. 9 after three repetitions of the steps of the method according to the invention, and

FIG. 13 represents the mapping of the surface after processing of the data for the purposes of parameterizing the abrasion trajectory.

### DETAILED DESCRIPTION

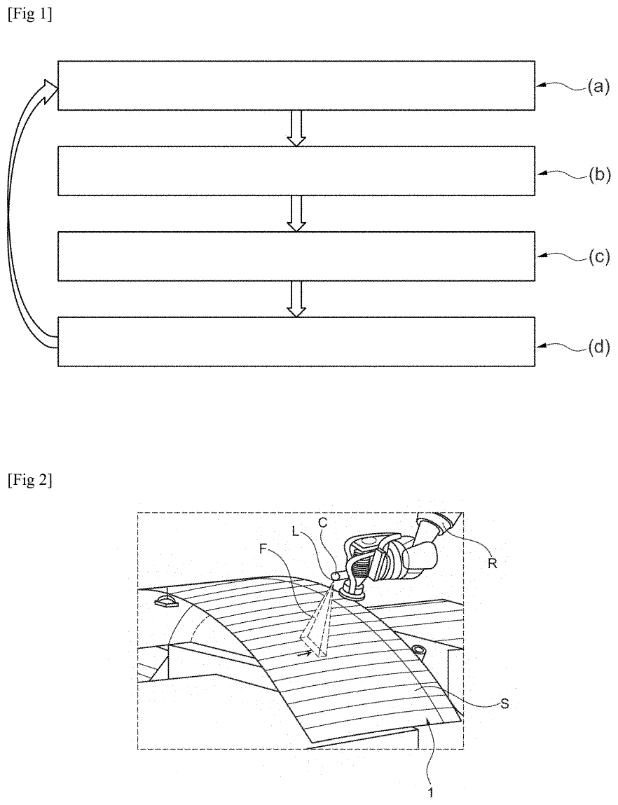

FIG. 1 represents an example of method for abrading a workpiece according to the invention comprising different steps. In a step (a), an acquisition is performed, with at least one sensor, over at least a part of the surface of the workpiece, to acquire data relating to at least one characteristic of the workpiece, in at least two basic zones defined on said acquisition surface.

In a second step (b), for each basic zone, data relating to said at least one characteristic are processed in order to assign, to each basic zone and/or to at least one set of basic zones, a value for that characteristic. A next step (c) consists in determining and/or adjusting at least one abrasion parameter of the abrasion machine and/or an abrasion trajectory as a function of the values assigned for the basic zones or set or sets of basic zones.

Finally, in the step (d), the abrasion of at least a part of the surface is performed with the abrasion machine with said at least one abrasion parameter and said abrasion trajectory. An initial trajectory and one or more abrasion parameters can be predetermined to obtain the most uniform possible abrasion. They can be implemented for the first abrasion pass. Preferably these steps are repeated at least one or two times, as indicated by the arrow going back up from the step (d) to the step (a), possibly excluding the step (d) if it is considered, after the step (b) and/or (c), that there is to be no more abrasion because the workpiece is sufficiently abraded.

Each of these steps of the method according to the invention will now be detailed.

FIG. 2 illustrates the acquisition step (a) of the method according to the invention. In this step, a robot R comprising a controller and provided with a sensor C incorporating a lamp L, performs a zigzag scanning of the surface S of a workpiece 1, in order to acquire data relating to a characteristic of the surface S of the workpiece. The beam F schematically represents the field of view of the sensor C.

In the example illustrated, the sensor C is a color detection sensor. The workpiece is composed of a final metal layer, bronze colored, a white intermediate layer and a yellow initial layer, which is the only one visible before the abrasion. The objective of the abrasion method is to obtain an even surface with the least possible material but without touching on the metal layer.

The characteristic on which data are acquired and processed is the color of the surface of the workpiece, in this example, in order to detect changes of color which make it possible to deduce information on the required abrasion level.

The workpiece 1 is substantially rectangular, being dished, as can be seen in FIG. 2, in this example. It can be of any form and dimensions without departing from the scope of the invention, advantageously having no relief on the surface to be treated.

During the acquisition step, all of the surface S is scanned by the robot to allow the acquisition of data. The acquisition trajectory is formed virtually by points evenly spaced apart in order to position the triggerings of the measurements, notably of color, in such a way that all of the workpiece is captured.

The taking of measurements by the sensor C can be triggered at predetermined distance and/or time intervals, in this example every 50 mm and/or every 10 ms.

The scanning speed can be 500 mm.s⁻¹ for example.

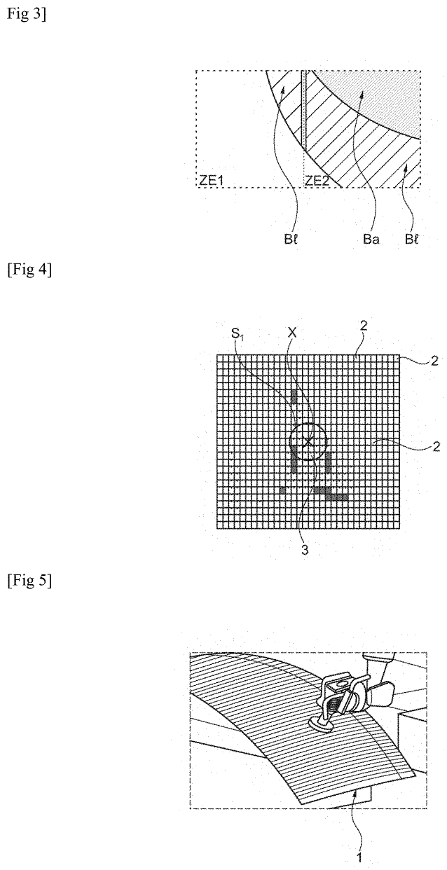

The result of some of these measurements is illustrated in FIG. 3. In the example considered, the measurement window of the sensor is divided into two basic zones. The sensor makes it possible to detect the final bronze color and the intermediate white color with filters called “OUT” and applied to each basic zone. The initial color, yellow, corresponds to the absence of the other two.

For each basic zone in the step (b), a processing is performed and a single color, corresponding to a value of the basic zone, is determined, and stored, by the controller according to a predefined hierarchy, for example bronze higher than white higher than yellow. As can be seen in FIG. 3, the presence of the white color B1 and the absence of bronze color is detected on the basic zone ZE1. That makes it possible to assign the white value to the basic zone ZE1. With respect to the basic zone ZE2, the bronze color Br and the white color B1 are detected, such that, by hierarchy, the bronze value is assigned to the basic zone ZE2.

It is also possible, in the processing step (b), for the assignment of a value to a processing zone, to adjust detection thresholds in order to disregard a color for a basic zone when it is present but in too small a quantity for that to require adapting the abrasion, notably the buffing.

The processing can be at least partially performed as the acquisition of the data progresses.

Data comprising a position, in the reference frame used by the abrasion machine at the moment of the measurement, and a color are assigned to different basic zones so as to form a mapping composed of basic zones 2, rectangular in this example, and colored, as can be seen in FIG. 4. In this example, as can be seen in the mapping derived from the acquisition processing, each basic zone 2 is represented by a colored rectangle.

In the processing step, for each point X, for example each point X of the initial abrasion trajectory, a surface Si is determined around this point X corresponding to the surface covered by the abrasive table of the abrasion machine. This surface Si can be seen in FIG. 4 and corresponds to that which is covered by a set 3 of basic zones 2. The set 3 of basic zones 2 forming the surface Si has a circular surface in this example, and the basic zones 2 that form it are rectangular, such that a processing is performed to determine the basic zones 2 that are taken into account for the computation or the determination of the value to be assigned to the set 5.

In the example considered, the value of each set 3 of basic zones is determined from at least one value of one of the basic zones of that set.

For example, it is possible to begin by comparing the values of the basic zones of the set 3 with a threshold value which can be the bronze final color. If one of the basic zones comprises the threshold value, then, this threshold value can be assigned to the set 3, such that the abrasion trajectory will avoid the surface Si of that set. If none of the values of the basic zones of the set 3 has reached the threshold value, then an average can be taken of the values of the basic zones of the set 3 to find the value of the set 3. The average could be weighted. Another criterion can be defined to determine the value of the set.

The value of the basic zones 2 and/or of the sets 3 therefore makes it possible to define an abrasion trajectory in the step (c), or to adjust it, for example from an initial or preceding abrasion trajectory, for example to avoid certain basic zones or sets of zones. The value of the basic zones 2 and/or of the sets 3 also makes it possible to define or adjust, still in the step (c) of the method, one or more parameters of the abrasion machine such as the speed of advance of the abrasive table, its speed of rotation, the effort applied by the machine during the abrasion of the surface, the changing of abrasive disk of the abrasive table, the abrasion grain size of the abrasive disk, the diameter of the abrasive table or other abrasion parameter.

Once the parameter or parameters and/or the abrasion trajectory have been determined and/or adjusted, they can be applied to the abrasion machine, to perform the abrasion, as illustrated in FIG. 5. In this example, the machine allowing the acquisition of data and the abrasion machine performing the abrasion are combined in one and the same rotor or robotized arm bearing, on the one hand, the acquisition tool, notably the sensor, and, on the other hand, the abrasive table.

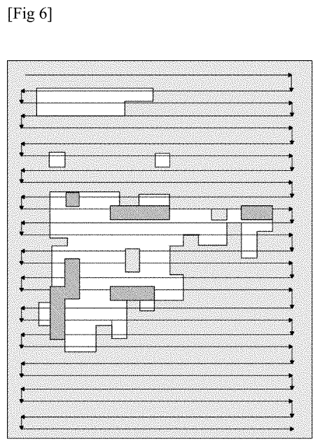

FIG. 6 illustrates an image of the mapped surface S, represented with the values of basic zones or of sets of basic zones that have been assigned corresponding to colors, whites, shaded or dark.

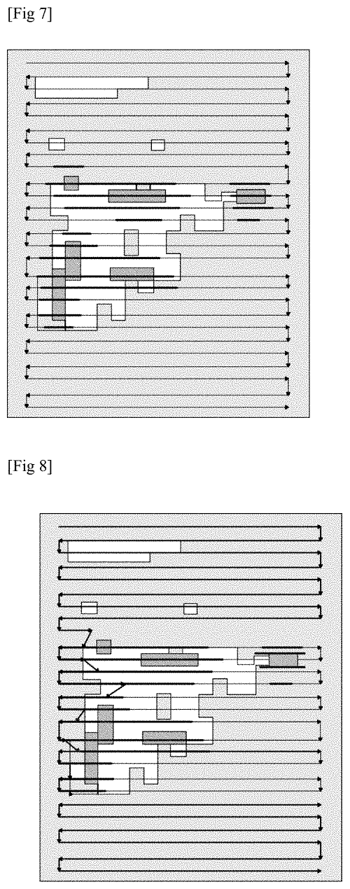

In FIG. 7, the image of the surface S comprises barred zones or sets, corresponding to the zones or sets to be avoided in the abrasion.

FIG. 8 illustrates the abrasion trajectory which is adjusted and plotted for the next abrasion, in order to avoid said zones or sets, for which the values assigned, consisting of colors, can be seen. Between each section of trajectory, the abrasion machine will have to disengage, move to a point of approach then begin buffing the next zone.

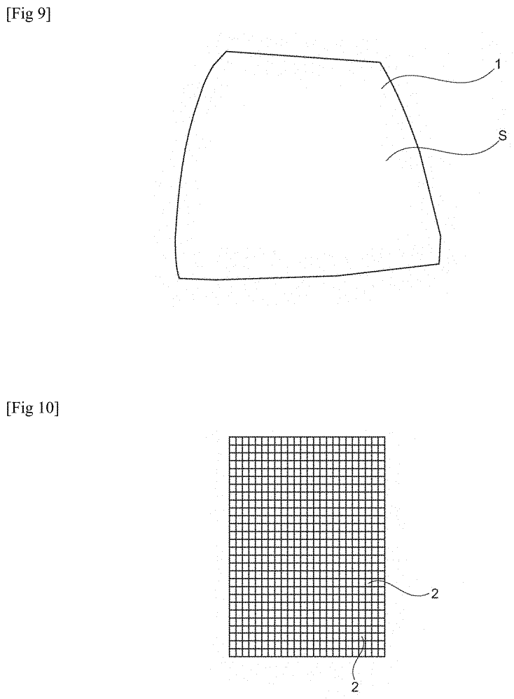

FIG. 9 shows a workpiece of uniform color, to be treated by buffing, of rectangular form, dished around at least one axis, and visible in perspective. The associated mapping of the surface S with basic zones 2, square in this example, of uniform color before buffing, is represented in FIG. 10.

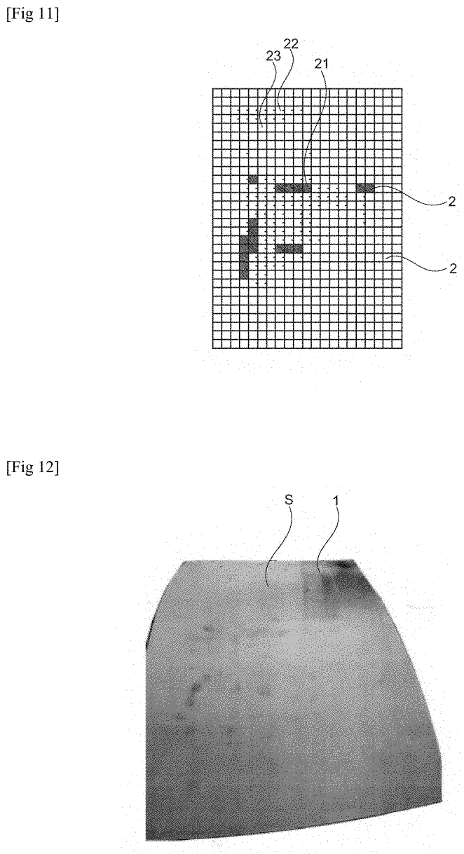

After implementation of all of the steps of the method according to the invention, at least once, even twice or three times or more, with minimum speed of advance parameters, for example, except in the U-turns where it is faster, it can be seen that the color of the surface S of the workpiece 1 is no longer uniform, as visible in FIG. 12. The associated mapping visible in FIG. 11 shows zones 21 of a darker color than the others, zones 22 of intermediate color and zones 23 of initial color. Dark spots on the zones 23 are detected by the sensor, so there are therefore zones to be avoided in the next abrasion. It is on the basis of this surface condition illustrated in FIG. 12 and mapped in FIG. 11 that the images of FIGS. 6, 7 and 8 have been printed, corresponding, successively, to the implementation of the step (c) of determination and/or of adjustment of the abrasion parameters and trajectory. In the zones 22 of intermediate color, it will be possible to modify the parameters to accelerate, for example, the speed of advance in order to less buff these zones.

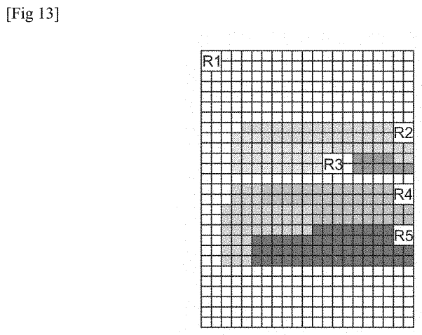

The parameters and the trajectory for the next abrasion are determined and illustrated in FIG. 13. After an optimization of the trajectory reconstruction algorithm, several of these regions can be merged to reduce the number of buffer inputs/outputs, in order to save time and/or avoid degrading the quality that can be brought about by the inputs/outputs. The regions R1, R2, R3, R4 and R5 in this FIG. 13 correspond to distinct abrasion trajectory sections.

The method is stopped, for example, when at least 80% of the surface S is no longer to be buffed, having reached the threshold value, when, for example, 80% of the surface in FIG. 13 is occupied by white zones or when it is no longer possible to reach zones to be abraded, that are too small with respect to the tool or when it is no longer possible to reduce the abrasion power of the abrasion machine.

It should be noted that, in the example considered, the surface S of the workpiece comprises a peripheral portion in proximity to at least one edge of the workpiece over a predetermined distance from the latter, said peripheral portion not being treated by the abrasion machine.

1. A method for abrading a surface of a workpiece by means of an abrasion machine, comprising the following steps:
Step a: acquisition, with at least one sensor, on at least a part of the surface of the workpiece, of data relating to at least one characteristic of the workpiece in at least two basic zones defined on said surface,
Step b: processing, for each basic zone, of the data relating to said at least one characteristic in order to assign, to each basic zone and/or to at least one set of basic zones a value for this characteristic,
Step c: determination and/or adjustment of at least one abrasion parameter of the abrasion machine and/or of an abrasion trajectory as a function of the values assigned for the basic zones or set or sets of basic zones,
Step d: abrasion of at least a part of the surface with the abrasion machine with said at least one abrasion parameter and said abrasion trajectory.

2. The method as claimed in claim 1, further comprising at least one repetition of the steps to (a) to (c).

3. The method as claimed in claim 2, further comprising at least one repetition of the step (d).

4. The method as claimed in claim 1, further comprising several repetitions of the steps (a) to (d), the last repetition not including the step (d).

5. The method as claimed in claim 1, wherein the abrasion machine moves relative to the workpiece during the abrasion step (d), the workpiece then being stationary.

6. The method as claimed in claim 1, wherein the workpiece and the abrasion machine are mobile with respect to one another, during the abrasion step (d).

7. The method as claimed in claim 1, wherein the workpiece is displaced relative to the abrasion machine during the abrasion step the abrasion machine then being stationary.

8. The method as claimed in claim 1, wherein said at least one characteristic of the workpiece is chosen from the group composed of a color, a dimension, notably a thickness, a surface condition such as a brightness or a roughness, a radiation.

9. The method as claimed in claim 1, wherein said at least one sensor is chosen from the group composed of a sensor with or without contact based on optical, mechanical, magnetic, capacitive, acoustic, radiative and piezoelectric technologies.

10. The method as claimed in claim 1, wherein said at least one abrasion parameter is chosen from among the following: speed of advance, speed of rotation or progress of the abrasive tool, effort applied by the abrasive tool on the surface of the workpiece, nature, form and/or size of the abrasive tool, angular orientation of the abrasive tool with respect to the local normal to the surface of the workpiece.

11. The method as claimed in claim 1, wherein the determination step c comprises a comparison, for each basic zone , of said value with a predetermined threshold value.

12. The method as claimed in claim 11, wherein, when, by implementation of the comparison, the threshold value for said at least one characteristic of the workpiece --14 is reached in at least one basic zone of a set of basic zones, the abrasion trajectory is determined so that there is no longer abrasion in the set of basic zones concerned.

13. The method as claimed in claim 11, wherein, when, by implementation of the comparison, the threshold value for said at least one characteristic of the workpiece is reached for at least a predefined percentage of the surface, of basic zones or set or sets of basic zones, the abrasion method is stopped.

14. The method as claimed in claim 1, wherein the abrasion consisting of a buffing.

15. The method as claimed in claim 1, implementing two different sensors for the performance of the acquisition step (a).

16. The method as claimed in claim 1, wherein the sensor or sensors comprise a color detection sensor, and the value assigned to each basic zone consists of a color.

17. The method as claimed in claim 1, wherein a set of basic zones comprises a plurality of basic zones present within a predetermined radius around a given point of the surface of the workpiece, the predetermined radius corresponding to that of an abrasive table of the abrasion machine.

18. The method as claimed in claim 13, wherein the predefined percentage of the surface is 80%.
